(19) United States
(12) Patent Application Publication
(10) Pub. No.: US 2026/0056008 A1
(43) Pub. Date: Feb. 26, 2026

(54) SHOT-NOISE LIMITED OPTICAL HYBRID SYSTEMS AND METHODS THEREOF

(71) Applicants: Al-Hafeez Zahir Dhalla, Durham, NC (US); Kristen Elizabeth Hagan, Seattle, WA (US); Kevin C. Zhou, Ann Arbor, MI (US); Joseph Adam Izatt, Raleigh, NC (US)

(72) Inventors: Al-Hafeez Zahir Dhalla, Durham, NC (US); Kristen Elizabeth Hagan, Seattle, WA (US); Kevin C. Zhou, Ann Arbor, MI (US); Joseph Adam Izatt, Raleigh, NC (US)

(21) Appl. No.: 19/305,471

(22) Filed: Aug. 20, 2025

Related U.S. Application Data
(60) Provisional application No. 63/684,922, filed on Aug. 20, 2024.

(51) Int. Cl. G01B 9/02091; G01B 9/02; G01B 9/02055

(52) U.S. Cl. CPC G01B 9/02091; G01B 9/02072; G01B 9/02083

(57) ABSTRACT

An interferometric quadrature detection system is disclosed that combines a reference or local oscillator signal with a sample or modulated signal in a fused fiber coupler having at least three outputs to generate phase-shifted signals. The phase-shifted signals are processed using either additional fused fiber couplers with balanced photoreceivers or single-ended photodetectors with subsequent analog subtraction to generate differential signals. The differential signals are used to reconstruct a complex-valued representation of the interferometric signal, enabling unambiguous recovery of amplitude and phase at or near the shot-noise limit. The disclosed methods and apparatus provide fiber-based alternatives to integrated optical hybrids and are applicable in optical coherence tomography, interferometric sensing, coherent optical communication systems and other applications.

### CLAIM OF PRIORITY

This application claims priority to U.S. Provisional Application No. 63/684,922, filed Aug. 20, 2024, the contents of which are incorporated herein by reference in their entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The present invention relates generally to interferometric optical systems, and more particularly to quadrature detection techniques in coherent optical receivers utilizing fused fiber couplers and balanced differential detection.

### BACKGROUND

Many optical systems require accurate measurement of both the amplitude and phase of an optical signal. Such systems are used in a wide variety of applications, including communications, sensing, imaging, and metrology. However, optical frequencies lie far above the bandwidth of conventional electronic circuits, making direct measurement of the oscillating optical field infeasible. Instead, most optical detectors operate as square-law devices, producing outputs proportional to the intensity of the incident light. While sufficient for many intensity-based measurements, square-law detection discards the underlying phase information carried by the optical field.

To overcome this limitation, many systems employ interferometric techniques, in which a reference optical beam is combined with a sample beam to generate interference fringes. The resulting interferograms encode both amplitude and phase differences between the optical fields. Analysis of these fringes enables measurement of nanoscale pathlength differences, sub-wavelength motion, refractive index variations, and other phase-sensitive properties that cannot be obtained from non-interferometric intensity measurements alone. Such interferometric principles are broadly applied in biomedical imaging, optical coherence tomography (OCT), optical metrology, and a wide range of fiber-optic sensors.

In order to reconstruct the full complex optical field from such interferometric measurements, it is necessary to obtain not only the in-phase component of the interference signal but also a corresponding signal shifted by 90°, or in quadrature. Together, these orthogonal components form a basis that allows both the real and imaginary parts of the optical field to be calculated. With quadrature detection, the magnitude and phase of the optical signal can be recovered unambiguously, eliminating fringe sign ambiguity and enabling phase-resolved measurements in real time.

Without access to quadrature information, interferometric techniques such as OCT and related Fourier-domain imaging and sensing methods are limited by the so-called complex conjugate ambiguity. When only real-valued interferometric data are acquired, the Fourier transform of the signal exhibits Hermitian symmetry, such that the reconstructed image contains mirror artifacts that obscure structures located on opposite sides of the zero-path-delay position. This conjugate ambiguity effectively halves the usable imaging or sensing depth of these systems, and in some cases introduces artifacts in the reconstructed data. By acquiring both in-phase and quadrature components of the interferometric signal, Hermitian symmetry is broken, the ambiguity is resolved, and full-depth, unambiguous imaging becomes possible. Thus, quadrature detection not only enables true complex field recovery but also directly improves the depth range and fidelity of OCT and related interferometric imaging modalities.

Numerous approaches have been developed to achieve quadrature detection in the context of biomedical imaging and fiber sensing. Sequential phase stepping interferometry can recover quadrature components by introducing controlled reference-arm phase shifts over multiple exposures, but is inherently sensitive to drift, vibration, and sample motion. Polarization-encoded systems generate orthogonal phase components simultaneously, but require complex and costly polarization optics, produce artifacts due to low extinction ratio polarization components, and cannot reliably interrogate birefringent samples. Heterodyne techniques, such as heterodyne swept-source OCT (SSOCT), shift one arm of the interferometer in frequency such that the interference signal is encoded as a beat note at the heterodyne frequency. By digitizing this frequency-shifted signal, quadrature components can be mathematically reconstructed. While these approaches are effective, they require complex and expensive optical modulators and thus have seen limited use outside of research environments.

Quadrature detection is also important in optical communications. Advanced modulation formats such as quadrature phase-shift keying (QPSK) and quadrature amplitude modulation (QAM) encode information onto both the in-phase (I) and quadrature (Q) components of an optical carrier. To recover such information at the receiver, the transmitted signal must be interfered with a local oscillator (LO) laser in a coherent receiver, and the resulting outputs must be detected in quadrature. Standard coherent receivers accomplish this function using integrated 90° optical hybrids. These optical hybrids are fabricated on photonic integrated circuit platforms and provide fixed 90° phase shifts in a compact form factor, enabling field-linear detection of the transmitted symbols. These techniques have enabled 100 Gbps, 400 Gbps, and higher-order coherent links now widely deployed in optical telecommunications. However, such integrated optical hybrids are costly, limited to telecom wavelength bands, and require complex fabrication.

Fused fiber couplers are widely used components in optical systems, formed by thermally fusing and tapering two or more optical fibers so that light launched into one port is distributed among multiple output ports. The most common implementations are 2×2 couplers, which combine or split signals between two input and two output fibers. In some cases, 2×2 couplers are configured as 1×2 splitters or combiners, which are functionally identical to 2×2 couplers, but with one port unused. Higher-order fused fiber couplers also exist, including 3×3 devices that distribute incoming light from three inputs among three outputs.

In an ideal 3×3 fused fiber coupler with uniform splitting, the three output signals exhibit approximately 120° relative phase shifts. In practice, the exact splitting ratios and phase offsets depend on fabrication tolerances and environmental stability, so the outputs deviate from perfectly uniform phase separation. Nevertheless, the near −120° phase spacing provides sufficient information to reconstruct both in-phase and quadrature components of the optical field. Specifically, by projecting the three outputs onto orthogonal axes in the complex plane, one can derive the real and imaginary parts of the field, thereby enabling quadrature projection without requiring moving parts, polarization encoding, modulators or integrated optical hybrids.

In optical detection, the fundamental sensitivity limit is set by shot noise, which arises from the quantum nature of light and represents the unavoidable statistical fluctuations in photon arrival. A system operating at the shot-noise limit achieves the best possible signal-to-noise ratio permitted by classical physics. In practice, however, most interferometric systems are hindered by excess noise, such as laser relative intensity noise or source instability, which add to the noise floor and degrade sensitivity from the shot-noise limit.

To achieve shot-noise-limited performance, interferometric systems rely on a combination of interferometric gain and balanced detection. By combining a strong reference signal (or local oscillator) with the signal field, the resulting interference fringes are amplified well above the detector's thermal and electronic noise floor. However, the higher reference power that enables this gain also introduces excess noise, including relative intensity noise (RIN) and source instabilities. Balanced detection addresses this trade-off by directing the two outputs of a Mach-Zehnder interferometer, which are 180 degrees out of phase, onto matched photodiodes and subtracting their currents. This subtraction both doubles the useful signal and cancels common-mode fluctuations, thereby suppressing excess noise and enabling operation at or close to the shot-noise limit. In addition, elimination of the signal's DC component in differential detection schemes maximizes the dynamic range of detector and digitizer. Balanced detection is widely adopted in optical systems, notably SS-OCT, where in combination with interferometric gain it significantly improves signal-to-noise ratio and often enables shot-noise-limited performance with sensitivities exceeding 100 dB.

Although digital subtraction of detector outputs has been explored in certain implementations, such approaches are inherently limited. When the subtraction is performed digitally, excess noise can only be suppressed to the resolution limit of the analog-to-digital converter, i.e., the least significant bit (LSB) level. By contrast, subtraction in the analog domain, after photodetection but before digitization, allows excess noise to be suppressed beneath the LSB threshold of the converter, thereby providing superior noise rejection. Moreover, digital subtraction cannot fully mitigate aliased noise components that enter during digitization, whereas analog subtraction prevents such noise from ever being digitized.

Although 3×3 fused fiber couplers inherently provide phase-shifted outputs suitable for quadrature projection, existing implementations have almost universally employed single-ended photodetection, in which each output is measured independently. This configuration permits mathematical reconstruction of quadrature components, but it fails to suppress common-mode fluctuations from the reference or local oscillator. As a result, excess noise sources such as relative intensity noise and source instability dominate at the higher reference powers required for interferometric gain, preventing operation at the shot-noise limit. These limitations have restricted the use of 3×3-based quadrature receivers in practice.

Thus, there remains a need for a simple, fiber-based quadrature detection architecture that combines the phase-separation capability of 3×3 couplers with the noise-rejection advantages of balanced detection. Such an approach would enable shot-noise-limited quadrature performance across a broad range of applications, from OCT and biomedical imaging, where it could extend depth range and improve image fidelity, to distributed fiber sensing and industrial metrology, where it could increase sensitivity and stability, to coherent communications and LiDAR, where it could serve as a cost-effective and wavelength-flexible alternative to polarization encodings, optical modulators, or integrated optical hybrids.

### SUMMARY OF THE DISCLOSURE

Described herein are methods, apparatus, systems, and computer-readable media for quadrature detection in interferometric optical systems. In certain embodiments, a coherent receiver is provided that utilizes fused fiber couplers in combination with balanced detection to enable unambiguous reconstruction of both the real and imaginary components of an optical field at or near the shot-noise limit.

In one aspect, a method is disclosed in which a first optical signal and a second optical signal are combined in a fused fiber coupler having at least three outputs to generate a plurality of phase-shifted signals. The phase-shifted signals are each subsequently divided using one or more additional fused fiber couplers, and the resulting signals are directed to balanced photoreceivers. Differential signals produced by the balanced detectors are then processed to reconstruct quadrature components of the combined optical signal.

In another aspect, a method is disclosed in which a first optical signal and a second optical signal are combined in a fused fiber coupler having three outputs to generate approximately 120° phase-shifted interferometric signals. The phase-shifted signals are each subsequently divided by additional fused fiber couplers, and the resulting signals are directed to balanced photoreceivers. The differential signals are processed to reconstruct quadrature components of the combined optical signal.

In another aspect, an apparatus is disclosed comprising a fused fiber coupler configured to generate multiple phase-shifted signals, one or more additional fused fiber couplers configured to divide the phase-shifted signals, and a plurality of balanced photoreceivers configured to form differential signals therefrom. A reconstruction module, which may be implemented in hardware, software, or a combination thereof, is configured to determine the real and imaginary parts of the optical field from the differential signals.

In another aspect, a system is disclosed comprising the apparatus described above in combination with a processing subsystem configured to perform calibration of offsets, fringe amplitudes, and phase deviations, and to accurately reconstruct quadrature components of the optical field. The system may be implemented in optical coherence tomography devices, interferometric fiber sensors, coherent communication receivers, or other types of systems.

In yet another aspect, a non-transitory computer-readable medium is disclosed storing instructions which, when executed by one or more processors, cause the processors to reconstruct quadrature components of an optical signal from differential detector outputs obtained as described herein.

The disclosed methods, apparatus, and systems leverage the inherent phase-separating properties of fused fiber couplers having at least three outputs, in combination with additional fused fiber couplers and balanced detection, to achieve quadrature projection with reduced sensitivity to excess photon noise. In certain embodiments, higher-order fiber couplers may be employed to provide additional phase-separated outputs. The disclosed approaches enable low-cost, fiber-based implementations of quadrature detection without the complexity or cost limitations of alternative approaches.

The methods, apparatus, and systems disclosed herein are broadly applicable across a variety of domains in which interferometric detection is employed, including but not limited to optical communications, optical coherence tomography (OCT), interferometric fiber sensing, biomedical and industrial imaging, precision metrology, and LiDAR.

### BRIEF DESCRIPTION OF THE DRAWINGS

A better understanding of the features and advantages of the systems, methods and apparatuses described herein will be obtained by reference to the following detailed description that sets forth illustrative embodiments, and the accompanying drawings.

FIG. 1 is a schematic diagram of an interferometric quadrature detection system (100) configured such that a first optical signal (101) and a second optical signal (102) are combined in a 3×3 fused fiber coupler (103) configured to use two input ports and three output ports. The fused fiber coupler generates a plurality of phase-shifted signals (104a, 104b, and 104c). Each of the phase-shifted signals is subsequently divided optically using an additional 2×2 fused fiber coupler (105a, 105b, and 105c), each configured to use one input port and two output ports. These additional 2×2 couplers create signal copies (106aa, 106ab, 106ba, 106bb, 106ca, and 106cb) that are directed to three balanced photoreceivers (107a, 107b, and 107c) configured for balanced detection. These balanced photoreceivers then output three differential electrical signals (108a, 108b, and 108c) which are digitized on a digitizer (109).

FIG. 2 is a schematic diagram of an alternative interferometric quadrature detection system (200) configured such that a first optical signal (101) and a second optical signal (102) are combined in a 3×3 fused fiber coupler (103) configured to use two input ports and three output ports. The fused fiber coupler generates a plurality of phase-shifted signals (104a, 104b, and 104c) which are directed to single-ended photodetectors (205a, 205b, and 205c). The phase-shifted signals (206a, 206b, and 206c) are obtained directly from the photodetectors and subtracted using analog circuitry (207) to generate the differential signals (208a, 208b, and 208c) before being digitized in a digitizer (109).

### DETAILED DESCRIPTION

The following description illustrates exemplary embodiments of the disclosed quadrature detection architectures. It should be understood that the embodiments described herein are non-limiting examples, and that variations, substitutions, and equivalents will be apparent to those of ordinary skill in the art.

As used herein, references to a “3×3 fused fiber coupler” should be understood to include devices having three output ports and at least one input port, such as 3×3, 2×3 or 1×3 fused fiber couplers. Similarly, references to a “2×2 fused fiber coupler” should be understood to include devices having two output ports and at least one input port, such as 2×2 or 1×2 fused fiber couplers. In general, couplers described by port count herein should be interpreted to cover functionally equivalent devices in which one or more ports may be unused or terminated without altering the fundamental operation described.

As used herein, fused fiber couplers should be understood to be reciprocal optical devices. Light launched into any subset of ports is distributed among the remaining ports according to the same coupling relationships, independent of direction of propagation. Accordingly, a coupler designated as “N×M” may be operated equivalently as an “M×N” device. For example, a device referred to as a 2×3 fused fiber coupler is functionally identical to a 3×2 fused fiber coupler. Similarly, a 1×2 fused fiber coupler is functionally identical to a 2×1 fused fiber coupler. References herein to a fused fiber coupler of a given port count should therefore be interpreted to cover the device when used in either direction of propagation.

As used herein, the term “quadrature detection” refers broadly to reconstructing a complex-valued representation of the interferometric signal in an optical system. Quadrature detection may be implemented by directly obtaining signals that are nominally 90° out of phase (e.g., in-phase, I, and quadrature, Q, components in a coherent receiver), or by mathematically reconstructing orthogonal components from other sets of phase-shifted signals, such as the ˜ 120° separated outputs of a 3×3 fused fiber coupler. Such methods may, depending on the implementation, recover the real and imaginary components of the optical field, or equivalently recover the I and Q components, according to the needs of the application. In either case, the result is an unambiguous complex-valued representation of the interferometric signal suitable for phase-resolved detection, and all such approaches are encompassed within the meaning of the term “quadrature detection” as used in this disclosure.

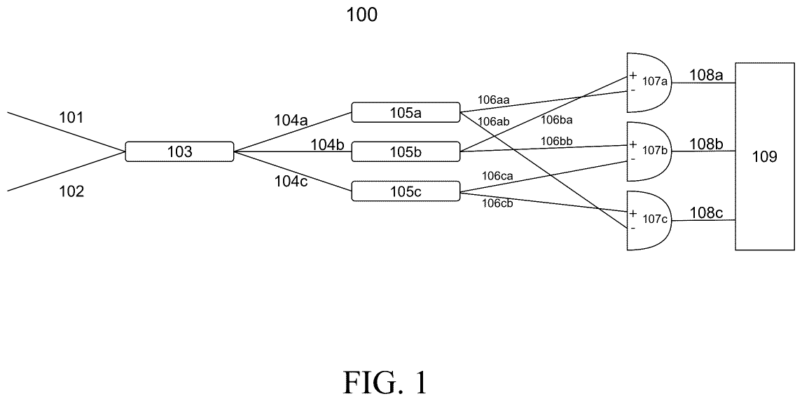

In an exemplary embodiment, depicted in FIG. 1, an interferometric quadrature detection system (100) is configured such that a first optical signal (101) and a second optical signal (102) are combined in a 3×3 fused fiber coupler (103) configured to use two input ports and three output ports. The two input optical signals may include, for example, a reference signal and a sample signal for interferometric imaging or sensing, or a local oscillator (LO) and a received modulated signal in coherent communications. The fused fiber coupler generates a plurality of phase-shifted signals, ideally separated by approximately 120° (104a, 104b and 104c). These signals may deviate from exact uniform spacing due to fabrication tolerances or environmental effects, but calibration procedures may be used to correct for such deviations.

Each of the phase-shifted signals is subsequently divided optically using an additional 2×2 fused fiber coupler (105a, 105b, and 105c), each configured to use one input port and two output ports. These additional 2×2 couplers create signal copies (106aa, 106ab, 106ba, 106bb, 106ca, and 106cb) that are directed to three balanced photoreceivers (107a, 107b and 107c) configured for balanced detection. These balanced photoreceivers then output three differential electrical signals (108a, 108b, and 108c) which are digitized on a digitizer (109).

The use of balanced photodetection provides cancellation of common-mode noise sources (excess noise) thereby enabling operation at or near the shot-noise limit, particularly when combined with interferometric gain from a strong reference or LO. The subtraction of the detector outputs is performed in the analog domain, after photodetection but prior to digitization. Performing balanced detection in the analog regime provides at least two significant advantages. First, excess noise is suppressed prior to digitization, permitting suppression beneath the LSB level of the analog-to-digital converter, which is not achievable by digital subtraction alone. Second, the photoreceiver inherently acts as a low-pass filter, rejecting noise components above its bandwidth, and balanced detection in the analog domain cancels the majority of the excess noise that remains within the detection bandwidth. If digitization were performed first, out-of-band noise components could alias into the digitized signal and would thereafter no longer be able to be removed by digital subtraction.

The differential signals generated by the balanced detectors are processed to reconstruct quadrature components of the combined optical signal. In an ideal configuration, a scaled combination of two differential signals yields the real component, while a third differential signal provides the imaginary component. The result is an unambiguous representation of both the real and imaginary parts of the optical field. Calibration routines may be applied to compensate for non-ideal splitting ratios, unequal detector responses, or phase deviations. Such calibration may be accomplished through mathematical fitting, digital signal processing (DSP), or pre-characterization of the coupler outputs.

In an ideal configuration, the phase-shifted signal outputs from 3×3 fused fiber coupler may be calculated as shown in Eq. (1):

$$I\_i = A\_i + B\_i cos ( 2 k\_ 0 Δ z + δ\_i ) , i = 1 , 2 , 3 \qquad ( Eq . 1 )$$

where i is the index of the 3×3 fused fiber coupler output port, A_i represents the DC value dependent on reference and sample reflectivity and returned power at port i, B_i is the fringe depth of the interferogram at port i, k_0=2π/λ_0 is the wavenumber at center wavelength λ_0, Δz is the optical path length difference between reference and sample arms, and δ_i is the phase offset generated by the coupler at port i.

For an ideal 3×3 coupler, the outputs exhibit phase offsets of −120°, 0°, and 120° (for i=1, 2 and 3, respectively). These can be combined to reconstruct the real and imaginary parts of the complex-valued signal as shown in Eq. (2)-(3):

$$Re ( I\_ 0 ) = B cos ( 2 k\_ 0 Δ z ) = ( 2 I\_ 2 - ( I\_ 1 + I\_ 3 ) ) / 3 = ( ΔI\_ 21 + ΔI\_ 23 ) / 3 \qquad ( Eq . 2 )$$

$$Im ( I\_ 0 ) = B sin ( 2 k\_ 0 Δ z ) = ( I\_ 3 - I\_ 1 ) / sqrt ( 3 ) = ΔI\_ 31 / sqrt ( 3 ) \qquad ( Eq . 3 )$$

where B is the fringe amplitude, Re is the real component of the interferometric signal, Im is the imaginary component of the interferometric signal, ΔI_ij denotes the differential signal output from the 2×2 coupler connected to ports i and j, such that, for ideal couplers, ΔI_ij=I_i-I_j. This demonstrates that quadrature components may be obtained directly from differential combinations of the three 2×2 coupler outputs.

In practice, fabrication and environmental tolerances introduce deviations from the ideal case. The differential signals may therefore be written in an extended form to include cascaded error from actual system parameters A_ij, B_ij and δ_ij, as follows:

$$Δ I\_ij = A\_ij + B\_ij cos ( 2 k\_ 0 Δ z - δ\_ij ) \qquad ( Eq . 4 )$$

$$A\_ij = A\_i - A\_j \qquad ( Eq . 5 )$$

$$B\_ij = sqrt ( ( B\_j sin δ\_j - B\_i sin δ\_i ) \hat{} 2 + ( B\_i cos δ\_i - B\_j cos δ\_j ) \hat{} 2 ) \qquad ( Eq . 6 )$$

$$δ\_ij = tan \hat{} - 1 [ ( B\_j sin δ\_j - B\_i sin δ\_i ) / ( B\_i cos δ\_i - B\_j cos δ\_j ) ] \qquad ( Eq . 7 )$$

These expressions account for DC imbalance, unequal fringe depth, and phase offset deviations.

A calibration routine may then be applied directly on the differential outputs. One calibration method employs ellipse-fitting. In such a method, the measured parameters A_ij, B_ij, δ_ij may be extracted and used to solve for the quadrature components. Rearranging Eq. (4)-(7), the relationship between measured differential outputs and the desired real and imaginary components may be written in matrix form as:

$$\begin{matrix}[ ΔI\_ 21 - A\_ 21 ] & [ B\_ 21 & 0 ] & [ Re ] \\ [ ΔI\_ 23 - A\_ 23 ] = & [ B\_ 23 cos δ\_ 23 & B\_ 23 sinδ\_ 23 ] & [ Im ] \\ [ ΔI\_ 31 - A\_ 31 ] & [ B\_ 31 cosδ\_ 31 & - B\_ 31 sinδ\_ 31 ] & \\\end{matrix} \qquad ( Eq . 8 )$$

Several approaches to inverting Eq. (8) to solve for Re and Im are possible, including direct inversion, numerical solutions based on different error criteria (e.g., mean square error, mean absolute error), optionally incorporating regularization terms, and various inversion methods such as closed-form least-squares solutions, gradient descent or other iterative methods, and stochastic optimization algorithms. In one embodiment, a least-squares solution to Eq. (8) yields Re and Im, from which the magnitude and phase of B may be calculated. This calibration framework enables robust quadrature reconstruction even under non-ideal conditions.

The theoretical shot-noise-limited performance of the architecture in this exemplary embodiment may be determined as follows. The signal outputs from the fused fiber coupler may be related to reference and sample powers as described in Eq. (9):

$$I\_i = ( ρ / 3 ) ( P\_r + P\_s + 2 sqrt ( P\_r P\_s ) cos ( 2 k\_ 0 Δ z + δ\_i ) ) \qquad ( Eq . 9 )$$

where P_R and P_S are the reference (or local oscillator) and sample (or modulated signal) powers, p is detector responsivity, and δ_i are the nominal phase offsets. The squared signal magnitude can be calculated using Eq. (10):

$$\vert B \vert \hat{} 2 = ( ρ \hat{} 2 P\_R P\_S ) / 9 \qquad ( Eq . 10 )$$

wherein all terms have been previously defined. The photocurrent variance due to shot-noise at each of the six single photodetectors can be calculated from Eq. (11):

$$σ\_shot \hat{} 2 = 2 q W < I\_i > \qquad ( Eq . 11 )$$

where W is detection bandwidth and q is electronic charge. The total variance can then be calculated using error propagation, as demonstrated in Eq. (12):

$$σ \hat{} 2 \_ ( \vert B \vert ) = ( 5 q W ρ P\_R ) / 27 \qquad ( Eq . 12 )$$

wherein P_R is assumed to be much greater than P_S. Finally, the shot-noise-limit sensitivity in this P_R>>P_S condition is given by Eq. (13):

$$SNR\_shot = \vert B \vert / σ \hat{} 2 \_ ( \vert B \vert ) = ( 3 ρ P\_S ) / ( 5 q W ) \qquad ( Eq . 13 )$$

wherein SNR_shot is the shot-noise-limited sensitivity, expressed as the signal-to-noise ratio of a theoretical perfect reflector, as is common practice within the field of OCT.

Thus, the sensitivity of this exemplary embodiment of the disclosed invention falls between the single-ended 3×3 case and the differential 2×2 interferometer case. This result arises because the noise variance for the 3×3 differential system increases relative to a typical 2×2 system due to the presence of an additional independent receiver, while the 120° out-of-phase subtractions generate a sqrt (3)-fold signal gain, as opposed to the two-fold improvement obtained when subtracting 180° out-of-phase signals.

The above mathematical framework provides the basis for implementing quadrature detection using fused fiber couplers and balanced detectors. In some embodiments, the reconstruction and calibration steps are performed by digital signal processing software. In such cases, a non-transitory computer-readable medium may store instructions which, when executed by one or more processors, cause the processors to perform operations according to the foregoing equations and find the least-squares solution to Eq. (8), thereby reconstructing real and imaginary components of the optical field from the differential detector outputs.

It will be understood that the phase-shifted outputs from the fused fiber 3×3 coupler may be combined with balanced photoreceivers in a number of different configurations. When each of the outputs is divided by additional 2×2 couplers, six optical channels are available for connection to three balanced photoreceivers with six inputs. Multiple valid permutations exist for assigning these six optical channels to the six photoreceiver inputs. Many such permutations, including the configuration illustrated in FIG. 1, provide useful measurements that can be processed using the reconstruction and calibration methods disclosed herein. However, invalid configurations, i.e. those in which both outputs of a single 2×2 coupler are directed to the same balanced detector, do not provide useful information. The present invention encompasses all valid permutations of optical connections between the coupler outputs and the balanced detector inputs that provide useful information.

Although the foregoing embodiment is described with reference to a 3×3 fused fiber coupler and three additional 2×2 fused fiber couplers, the invention is not limited to this exact topology. More generally, the initial coupler need only provide at least three phase-shifted outputs, and references to a “3×3 coupler” should be understood to encompass equivalent devices such as 2×3 couplers. Likewise, references to “2×2 couplers” should be understood to encompass any fused fiber coupler used to divide an optical signal into multiple paths, including 1×2 or higher-order devices. In certain embodiments, couplers having more than three outputs may be employed, although the resulting phase separations would not necessarily be 120°, and the mathematical reconstruction of quadrature components would be modified accordingly. These variations remain within the scope of the disclosed quadrature detection architecture.

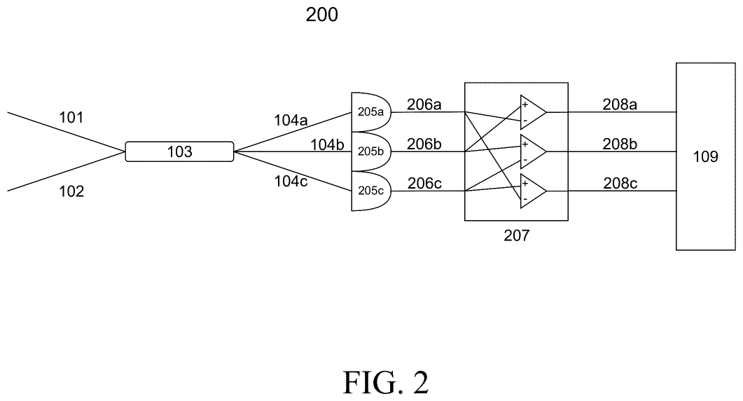

In another embodiment, as depicted in FIG. 2, an alternative interferometric quadrature detection system (200) is configured such that the outputs (104a, 104b, and 104c) of the fused fiber coupler (103) having at least three outputs are directed to single-ended photodetectors (205a, 205b, and 205c), without first being divided by additional fused fiber couplers. In such a configuration, the phase-shifted signals (206a, 206b, and 206c) are obtained directly from the photodetectors and subtracted using analog circuitry (207) to generate the differential signals (208a, 208b, and 208c) before being digitized in a digitizer (109). This approach implements the functional role of the additional 2×2 couplers from quadrature detection system 100 in the electrical domain rather than the optical domain. The subtraction is still performed in the analog domain, and thus this approach still maintains the advantages of balanced detection prior to digitization. The calculations and calibration methods described herein for systems employing additional 2×2 couplers are equally applicable to embodiments in which splitting and subtraction are performed in the electrical domain.

The performance of the disclosed architectures may depend on the splitting ratios of the fused fiber couplers employed. For fused fiber 3×3 couplers, the splitting ratio directly affects the relative phase shifts between the output ports. In an ideal device, optical power is distributed equally among the three outputs, producing relative phase shifts of approximately 120 degrees. However, in practice, deviations in splitting ratios lead to phase separations that differ from the ideal case. The calibration and reconstruction methods disclosed herein, as well as other equivalent approaches, can be applied to correct for such deviations and to recover accurate quadrature information from non-ideal couplers. For fused fiber 2×2 couplers used as simple power splitters, the splitting ratio does not generate a phase shift but nonetheless influences the performance of balanced detection. Equal splitting ratios provide optimal common-mode noise rejection, yet the disclosed calibration methods and other equivalent techniques may also be applied to systems in which the splitting ratios are unequal, thereby ensuring robust operation even in the presence of non-idealities.

The disclosed architectures are broadly applicable. In biomedical imaging and optical coherence tomography (OCT), the ability to recover quadrature components eliminates complex conjugate artifacts associated with Hermitian symmetry, thereby extending imaging depth and improving fidelity. In fiber-optic sensing and precision metrology, quadrature detection improves sensitivity to displacement, strain, vibration, and refractive index variations. In coherent optical communications, the disclosed architecture functions as a fiber-based alternative to integrated 90° hybrids, enabling demodulation of QPSK, QAM, and related modulation formats at or near the shot-noise limit without the cost or wavelength restrictions of integrated photonic hybrids. In coherent LiDAR and related applications, the disclosed approach enables robust quadrature detection for ranging and velocity measurements.

In certain embodiments, the reconstruction of quadrature components is performed by a dedicated reconstruction module. The module may include analog circuitry, digital hardware, firmware, or software executed by one or more processors. In some embodiments, the reconstruction module comprises a non-transitory computer-readable medium storing instructions that, when executed by one or more processors, cause the processors to reconstruct quadrature components of an optical signal from differential detector outputs. Such software may also implement calibration routines, digital filtering, or signal processing algorithms to correct for non-idealities in the couplers and detectors.

Thus, the disclosed methods, apparatus, systems, and computer-readable media leverage fused fiber couplers with at least three outputs, additional fused fiber couplers, and balanced photodetection to provide a low-cost, wavelength-flexible, and shot-noise-limited approach to quadrature detection. The embodiments described herein illustrate, without limitation, how the invention may be implemented across diverse domains including optical communications, imaging, sensing, metrology, and LiDAR.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of quadrature detection in an interferometric optical system, comprising:
combining a first optical signal and a second optical signal in a fused fiber coupler having at least three outputs to generate a plurality of phase-shifted signals;
obtaining differential signals from the phase-shifted signals by either (i) dividing each of the phase-shifted signals using one or more additional fused fiber couplers to produce multiple optical copies and directing the optical copies to balanced photoreceivers, or (ii) directing the phase-shifted signals to photodetectors and subtracting the resulting electrical outputs in the analog domain; and
reconstructing a complex-valued representation of the interferometric signal from the differential signals.

2. The method of claim 1, wherein the first optical signal is a reference or local oscillator and the second optical signal is a sample or modulated communication signal.

3. The method of claim 1, wherein the optical system comprises an optical coherence tomography (OCT) device or interferometric imaging device.

4. The method of claim 1, wherein the optical system comprises a coherent optical communication receiver.

5. The method of claim 1, further comprising calibrating offsets and phase deviations of the outputs prior to reconstruction.

6. The method of claim 1, wherein reconstructing comprises either computing a real component from a scaled average of two differential signals and an imaginary component from a third differential signal or computing an imaginary component from a scaled average of two differential signals and a real component from a third differential signal.

7. An interferometric receiver apparatus comprising:
a fused fiber coupler having at least three outputs and configured to combine a first optical signal and a second optical signal to generate a plurality of phase-shifted signals; and
elements configured to obtain differential signals from the phase-shifted signals by either (i) dividing the phase-shifted signals using one or more additional fused fiber couplers to produce multiple optical copies and directing the optical copies to balanced photoreceivers, or (ii) directing the phase-shifted signals to photodetectors and subtracting the resulting electrical outputs in the analog domain.

8. The apparatus of claim 7, wherein the apparatus is configured for optical coherence tomography or interferometric imaging.

9. The apparatus of claim 7, wherein the apparatus is configured as a coherent optical communication receiver.

10. The apparatus of claim 7, wherein the plurality of phase-shifted signals are separated by approximately 120 degrees.

11. The apparatus of claim 7, wherein the balanced photoreceivers are configured to suppress common-mode noise, including relative intensity noise, of a reference or local oscillator optical signal.

12. The apparatus of claim 7, wherein the apparatus further comprises optical fiber components operable across multiple wavelength bands.

13. A quadrature detection system comprising:
the interferometric receiver apparatus of claim 7; and
a reconstruction module configured to process the differential signals and determine a complex-valued representation of the interferometric signal.

14. The system of claim 13, wherein the reconstruction module determines in-phase (I) and quadrature (Q) components of the optical signal.

15. The system of claim 13, wherein the reconstruction module reconstructs the real and imaginary components of the optical field from differential combinations of phase-shifted signals.

16. The system of claim 13, wherein the system is implemented in a coherent optical communication receiver.

17. The system of claim 16, wherein the coherent optical communication receiver employs quadrature amplitude modulation (QAM), phase-shift keying (PSK), or another coherent modulation format.

18. The system of claim 13, wherein the system is implemented in an OCT device or interferometric imaging device.

19. The system of claim 13, wherein the system is implemented in a fiber-optic sensor for displacement, strain, or refractive index measurement.

20. The system of claim 13, wherein the reconstruction module comprises instructions stored on a non-transitory computer-readable medium that, when executed by one or more processors, cause the processors to reconstruct a complex-valued representation of the interferometric signal from the differential signals.
